(19) United States
(12) Patent Application Publication
(10) Pub. No.: US 2016/0180292 A1
(43) Pub. Date: Jun. 23, 2016

(54) Electronic Medical Evaluation Software

(71) Applicant: Prime Medical, LLC, Baton Rouge, LA (US)

(72) Inventors: Sean H. Connor, Baton Rouge, LA (US); Luke P. Lee, Baton Rouge, LA (US)

(73) Assignee: Prime Medical, LLC

(21) Appl. No.: 14/788,850

(22) Filed: Jul. 1, 2015

Related U.S. Application Data
(63) Continuation-in-part of application No. 14/581,842, filed on Dec. 23, 2014.

(51) Int. Cl. G06Q 10/10

(52) U.S. Cl. CPC G06Q 10/1053; G06Q 10/1095

(57) ABSTRACT

A questionnaire including one or more questions associated with an ability of an employee to perform a job for an employer is provided. Answers to the one or more questions of the questionnaire are received from the employee. An evaluation of the one or more answers as to the ability of the employee to safely perform the essential aspects of his/her assigned job is determined. The employer is notified of the evaluation without providing the employer access to the answers provided by the employee.

### CROSS REFERENCE TO RELATED APPLICATIONS

I hereby claim benefit under Title 35, United States Code, Section 120 of U.S. patent application Ser. No. 14/581,842 filed Dec. 23, 2014. This application is a continuation-in-part of the Ser. No. 14/581,842 application. The Ser. No. 14/581,842 application is currently pending. The Ser. No. 14/581,842 application is hereby incorporated by reference into this application.

### FIELD OF THE INVENTION

The present invention relates generally to an electronic medical evaluation system.

### BACKGROUND OF THE INVENTION

Employers who hire employees to perform demanding jobs often need those employees to pass various medical exams and tests prior to a new, transfer, re-start, or similar starting of a job placement to determine whether or not the employees are medically fit to perform the essential aspects of his/her assigned job (this wording is related to employers need to comply with ADA). Some of these employees, particularly maritime or oil-patch employees, will be on site perform their jobs for weeks at a time. After a job completes, the employee may return to their home for an extended period of time before going back to the job site. Before the employee can safely return to the job site, the employee must be medically cleared to return. However, current procedures for full medical evaluations by a doctor can become very costly and time consuming for the both employer and employee. Similar situations and needs for medical fitness evaluation may also occur when an employee has had an extended leave of absence, a transfer to a new job or job location, or other similar change or break in employment duties.

### BRIEF SUMMARY OF THE INVENTION

A questionnaire including one or more questions associated with an ability of an employee to perform a job for an employer is provided. Answers to the one or more questions of the questionnaire are received from the employee. An evaluation of the one or more answers as to the ability of the employee to perform the job is determined. The employer is notified of the evaluation without providing the employer access to the answers provided by the employee.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of an electronic medical evaluation system, according to an example embodiment.

FIG. 2 is an example employer interface of electronic medical evaluation system, according to an embodiment.

FIG. 3 is another example employer interface of electronic medical evaluation system, according to an embodiment.

FIG. 4 is an example clinic interface of electronic medical evaluation system, according to an embodiment.

FIG. 5 is another example clinic interface of electronic medical evaluation system, according to an embodiment.

FIG. 6 is an example reviewer interface of electronic medical evaluation system, according to an embodiment.

FIG. 7 is another example reviewer interface of electronic medical evaluation system, according to an embodiment.

FIG. 8 is a flowchart illustrating a process executed by electronic medical evaluation system, according to an example embodiment.

FIG. 9 is a flowchart illustrating an example review process, according to an embodiment.

FIGS. 10A-F are example portions of a questionnaire that may be provided by the electronics medical evaluation system to an employee, according to an embodiment.

FIG. 11 is a flowchart illustrating an example process of evaluating whether an employee is able to perform a job, according to an embodiment.

### DETAILED DESCRIPTION OF THE INVENTION

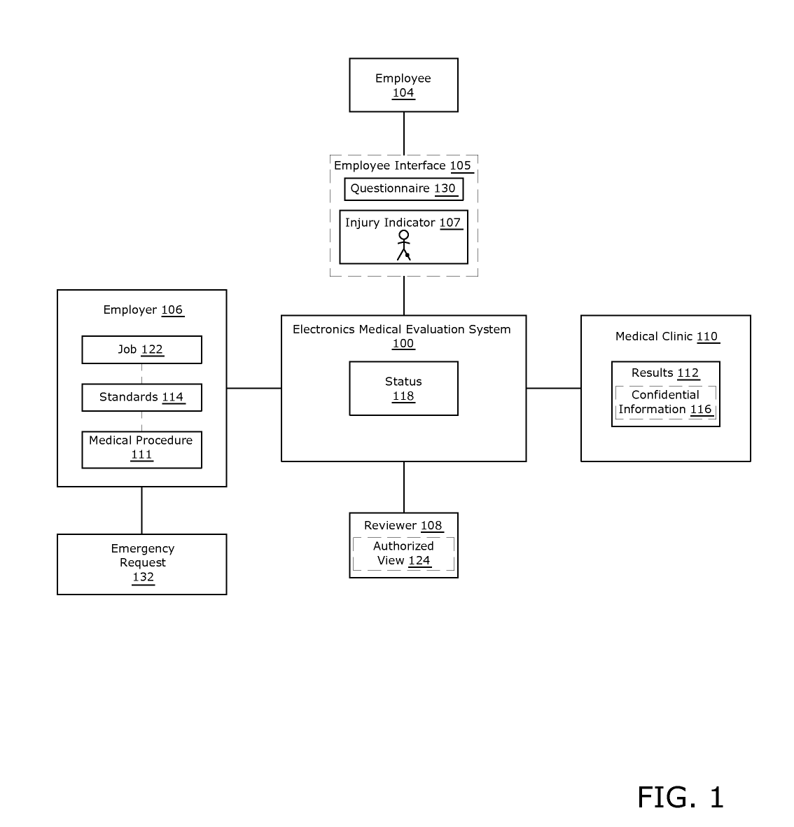

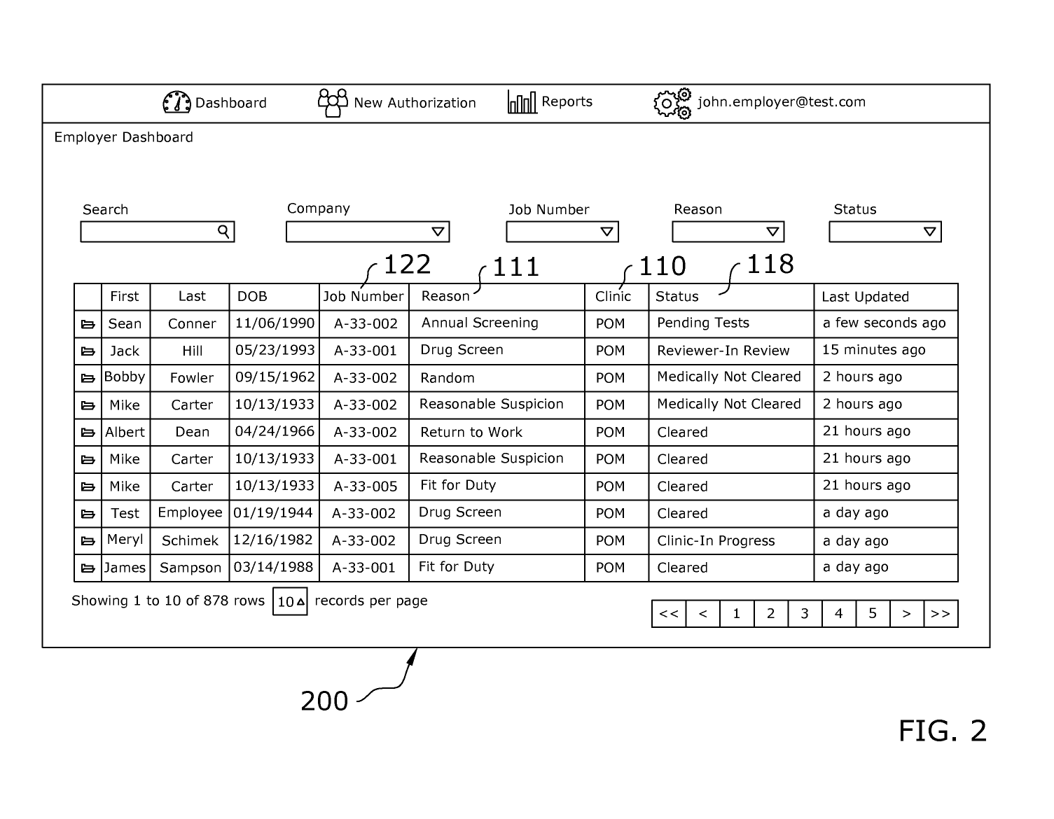

FIG. 1 is a block diagram of an electronic medical evaluation system 100, according to an example embodiment. The electronic medical evaluation system 100 is a system that provides coordination and varied levels access to medical information of employees 104, employers 106, reviewers 108, and medical clinics 110.

An employer 106 may request that an employee 104 undergo a medical procedure 111. Medical procedure 111 may be required by employer 106 to ensure that employee 104 is physically able to perform a job 122.

The electronic medical evaluation system 100 provides a centralized system by which the employer 106 is able track a status 118 and results 112 associated with the requested medical procedure 111. The electronic medical evaluation system 100 may provide the medical status 118 and results 112 associated with the performance of the requested medical procedure 111 to an employer 106. As described herein, electronic medical evaluation system 100 may allow an employer 106 to request multiple medical procedures 111 for one or more employees 104.

The electronic medical evaluation system 100 may protect the medical rights of the employee 104 by preventing the employer 106 from gaining access to any confidential information 116 about the employee 104 to which the employer 106 is not entitled while still enabling the employer 106 real-time access the status 118 and results 112. A reviewer 108 may redact or select a portion of results 112 and/or confidential information 116 to provide to or share with employer 106 in an authorized view 124 to ensure employer 106 does not view any confidential information 116 to which employer 106 is not entitled.

The electronic medical evaluation system 100 may ensure that medical clinics 110 are adhering to the standards of care 114 (standards 114) of the employer 106 for the performance of medical procedure 111. In an embodiment, standards 114 may provide guidelines or requirements as determined by employer 106 (or other organization) on how medical procedure 111 is to be performed. A reviewer 108 may review the results 112 and confidential information 116 to ensure that the standards 114 have been met by the medical clinic 110. Based on the evaluation, the reviewer 108 may accept, decline, or request additional information with regard to the results 112 provided by a medical clinic 110. The electronic medical evaluation system 100 may allow employers 106 to ensure that consistent medical care in accordance with standards 114 is being provided to employee 104 regardless of where or who is providing the medical care. In an embodiment, two different employers 106 may have different standards 114 for the same medical procedure 111. Or for example, one employer 106 may have a standard 114 for a medical procedure 111 that is being performed on two different employees 104 in two different states by two different medical clinics 110. The electronic medical evaluation system 100, through the review process described herein, may ensure that the proper standard of care 114 is being met by medical clinics 110 for each employer 106.

Employer 106 may be a company or other organization that hires employees 104 to perform jobs 122. Job 122 may be a position, duty, or task employee 104 may be required to perform as part of an employment or other agreement with employer 106. In an example embodiment, the performance of job 122 may require employee 104 be in a particular physical or mental state. For example, job 122 may require employee 104 be able to lift objects of a certain weight, or that employee 104 have a particular vision measurement (e.g., such as 20/20 vision). Or for example, employer 106 may require that all employees 104, regardless of job 122, be given drug tests. In order to ensure employees 104 meet the requirements of an employer 106 and/or job 122, employer 106 may require that employee 104 undergo one or more medical procedures 111 to ensure the fitness of employee 104 for performing job 122. The electronic medical evaluation system 100 may allow employer 106 to request the medical procedures 111 to be performed at a medical clinic 110 without having to call and set up an appointment with medical clinic 110.

Medical procedure 111 may be any medical procedure, test, or examination required or requested by employer 106 or employee 104. The results 112 of medical procedure 111 may be used to determine the employee's fitness to perform job 122. In an embodiment, passing medical procedure 111 may be a condition of employment or continued employment to perform job 122. Example medical procedures 111 include, but are not limited to, eye exam, hearing exam or audiograms, physical, drug tests, alcohol screening, blood tests, x-rays, stress test, psychiatric exams, x-rays, cat scans, MRIs, annual screenings, or other specialized exams or tests particular to performing job 122.

Employer 106 may have standards of care 114 (standards 114) for how one or more medical procedures 111 are performed. Standards 114 may be any requirement of employer 106 relating to how or which medical procedure 111 is performed. For example, standards 114 may include a requirement that a drug test 110 includes screening for a particular set and number of drugs. Or, for example, standards 114 may require that physical exams 110 for a first job 122 include a test to ensure whether employee 104 is able to lift a specified weight above his/her head, and that physical exams 110 for a second job 122 does not require such a test or tests a different weight. In an embodiment, standards 114 may include employer specific guidelines, other organizational guidelines, and/or laws regulating the performance of medical procedure 111.

As described above, employee 104 may be a prospective employee of employer 106 who is required to pass one or more medical procedures 111 to be employed by in one or more jobs 122. In another embodiment, employee 104 may already be employed by employer 106 and may sustain an injury while working at job 122. Then, for example, medical procedures 111 may include any tests or procedures necessary to diagnose and/or treat the injury.

Employee 104 may communicate with electronic medical evaluation system 100 through an employee interface 105. Employee interface 105 may be an app or program downloaded on a mobile device (e.g., such as a mobile phone), or may otherwise be accessible via the Internet or other network. Employee 104 may be able to access results 112 and/or confidential information 116 by way of employee interface 105. Employee interface 105 may allow for communication between employee 104 and reviewer 108 and/or medical clinic 110. In an embodiment, the communication may be deemed either confidential (inaccessible to employer 106), or non-confidential (to which employer 106 has access).

Employee interface 105 may allow employee 104 to indicate an injury by way of an injury indicator 107 which preferably is comprised of a body diagram. This body diagram may also be used in the interfaces for the data entry by the reviewer 108, medical clinic 110 and/or employer 106. In an embodiment, injury indicator 107 may provide employee 104 with a skeleton or other representation of a human figure and allow employee 104 to click to indicate the location of the injury or pain. For example, as shown, the X may indicate a pain in the employee's right knee. Employee interface 105 may be accessible to employee by way of a web browser or mobile application.

In another embodiment, employee interface 105 may provide access to employee medical information. Information about employee 104 may be provided by employer 106 and/or medical clinic 110. For example, employer 106 and/or medical clinic 110 may have access to injury indicator 107 via their own interface (e.g., dashboard) with electronic medical evaluation system 100.

The electronic medical evaluation system 100 may enable employer 106 or employee 104 to request medical procedures 111. After the receipt of a request for medical procedure 111, electronic medical evaluation system 100 may designate which medical clinic 110 is to perform the medical procedure 111. For example, employer 106 may be associated with or may contract with one or more medical clinics 110. Upon receipt of a request for one or more medical procedures 111, electronic medical evaluation system 100 may provide the requestor (employer 106 or employee 104) a list of one or more medical clinics 110 authorized to perform the requested procedures 111. The electronic medical evaluation system 100 may select the medical clinic(s) 110 based on any number of factors, including, location of job 122, location of employer 106, location of employee 104, cost, medical clinic's ability to perform the request procedures 111, whether or not employee 104 has visited the clinic before, wait time or busyness of medical clinics, and employee's preference.

In an embodiment, employee 104 may use employee interface 105 to receive and/or respond to a questionnaire 130. Questionnaire 130 may be a form, set of one or more questions, survey, or other evaluation interface used to request information and/or verification from employee 104. For example, questionnaire 130 may request medical information from employee 104. The medical information may include any information relevant to the employee's health or lifestyle, including activities that may directly or indirectly impact the employee's ability to perform job 122.

For example, employee 104 may already work for employer 106. Job 122 for which employee 104 was hired may require the employee 104 to travel to a remote or distant location for an extended period of time (e.g., days, weeks, months, etc.). Prior to departing for the initial job 122, employee 104 may be given a full medical evaluation as described herein. However, there may be periods of time between deployments (during the performance of one extended job 122, or multiple jobs 122) when the employee returns home or is otherwise given extended time away from the remote job site. These periods may be several days or several weeks.

When employee 104 is ready to be deployed again to the same or different job 122 at the same or different job site/location, employee 104 may not need a full medical evaluation by doctors or other medical personnel unless something substantive changed in the employee's medical situation since the previous deployment or medical evaluation. Such full evaluations may be expensive in terms of cost and time to employee 104 and/or employer 106. As such, employer 106 and/or employee 104 may prefer to avoid conducting such full evaluations unless necessary. These evaluations may be unnecessary if nothing substantial has changed in the employee's medical situation during the time off between one or more jobs 122.

In such situations, prior to or in lieu of performing such full medical evaluations, employee 104 may be provided questionnaire 130. Questionnaire 130 may be used to confirm the employee's medical fitness to perform the next job 122 for which employee 104 is to be deployed, or may otherwise be used to determine if there has been any changes in the employee's medical situation since the previous job 122 or deployment. For example, during the time away from job 122, it is possible employee 104 was injured, developed, or was diagnosed with a new medical condition, allergy, disease, or was otherwise prescribed medical relief or aid (e.g., prescriptions, physical therapy, glasses/contacts, suffered a sprain, a hearing aid, etc.).

It may be that under Federal or local laws, employer 106 is not allowed to ask employee 104 about the existence of certain medical conditions has or medications employee 104 may be taking The health insurance portability and accountability act (HIPAA) may be an example of a law that protects the employee's right to confidentiality from employer 106. In such a situation, a medically qualified intermediary such as reviewer 108 and/or electronics medical evaluation system 100 may evaluate the employee's answers to questionnaire 130 and make a determination to whether or not employee is able (still able) to safely perform the functions of job 122. This may enable employer 106 to comply with the law and/or the employee's privacy rights, while still ensuring the employee's fitness and safety with regard to performing the essentially aspects of the employee's assigned job 122.

In an embodiment, the answers may be provided through employee interface 105, to electronics medical evaluation system 100, and to reviewer 108. Reviewer 108 (or electronics medical evaluation system 100) may determine what, if any, new medical conditions employee 104 has reported via questionnaire 130. Based on a comparison of answers to functions required by job 122, reviewer 108 may make a determination as to employee's fitness. For example, reviewer 108 may determined that employee 104 is cleared, conditionally cleared, or not cleared. The results may then be reported to employer 106 (e.g., via electronics medical evaluation system 100) and/or employee 105 (e.g., via employee interface 105). In an embodiment, if employee 104 is conditionally cleared pending further information clarity or not cleared, then a medical procedure or evaluation may be scheduled with medical clinic 110 to determine the extent of employee's injury/situations and determine when employee 104 may resume work.

In an embodiment, electronics medical evaluation system 100 may perform an initial review of questionnaire 130 prior to reviewer 108. For example, if employee 104 answers every question with a negative (e.g., no new medical conditions or situations have occurred since a previous deployment or medical evaluation) or answers that are otherwise consistent with the employee's known medical history/information, employee 104 may be cleared by electronics medical evaluation system 100 and be allowed to return to job 122. The results or evaluation may be reported to employer 106 and/or employee 104. However, if employee 104 reported a new medical condition, then the employee's answers may be provided to reviewer 108 or other medical personnel for further evaluation.

In an embodiment, electronic medical evaluation system 100 may automatically select which medical clinic(s) 110 are to perform which medical procedure(s) for employee 104. The electronic medical evaluation system 100 may allow employer 106 and/or employee 104 to override the initial selection with another approved medical clinic 110.

Medical clinic 110 may be a hospital, doctor's office, a doctor, nurse, or other health clinic or provider with medical personnel authorized or licensed to perform one or more requested medical procedure(s). In an embodiment, medical clinic 110 may include emergency personnel, such as an EMT (emergency medical technician), paramedic, or other individual, who provided medical care to employee 104.

The electronic medical evaluation system 100 may receive results 112 of medical procedures 111 from medical clinic 110. Results 112 may include information indicating whether employee 104 passed or failed a medical exam 111 such as a drug screening, a diagnosis of an injury or disease, and/or a prescribed method of treatment (e.g., prescription, rest, training, surgery, re-test, etc.).

The electronic medical evaluation system 100 may also allow medical clinic 110 to upload confidential information 116 about employee 104 as relating to the employee's medical condition or more specific information about the medical procedure 111 performed. Confidential information 116 may include any information that employer may not be authorized to view. The confidential information 116 may be stored and managed by the electronic medical evaluation system 100. For example, employers 106 may be restricted from which medical information about an employee 104 they are allowed to access. These restrictions may be due to laws or other occupational or medical regulations. Results 112, by contrast, may indicate the results 112 of medical procedures 111 or other relevant information employer 106 is allowed to see/access. For example, employer 106 may be notified with results 112 that employee 104 failed a drug test 111, but may not be notified as for which of the test drug(s) the employee 104 failed or the level of drugs found in the employee's system because that additional detail may be confidential information 116.

In an embodiment, a reviewer 108 may review results 112 and/or confidential information 116 (collectively referred to herein as “medical information”) before it is provided to employer 106. Reviewer 108 may be any medical personnel (e.g., doctors, nurses, or other trained personnel) that review medical information received from medical clinic 110 prior to the submission of that medical information to employer 106 through electronic medical evaluation system 100.

Reviewer 108 may, for example, review medical information (results 112 and confidential information 116) to ensure standards 114 of employer 106 have been met by medical clinic 110. As an example, in a drug test, reviewer 108 may ensure all the indicated drugs in standards 114 were tested for by medical clinic 110. Through the reviewing process, electronic medical evaluation system 100 allows employer 106 to know its standards are being met without accessing restricted confidential information 116 (which may be accessible to reviewer 108) and regardless of which medical clinic 110 is performing the medical evaluation.

Based on the medical information, reviewer 108 may authorize the results 112 indicating that all standards 114 have been met, and results 112 may be released to employer 106. Reviewer 108 may decline the results 112, indicating that medical clinic 110 failed to meet one or more standards 114. Or, reviewer 108 may need additional information from medical clinic 110, in which case reviewer 108 may communicate directly with medical clinic 110 through electronic medical evaluation system 100, without employer 106 being able to see the communication. For example, electronic medical evaluation system 100 may have an electronic medical record including results 112 and confidential information 116, to which reviewer 108 may attach a note or question for medical clinic 110. The communication between reviewer 108 and medical clinic 110 may be included as part of the employee's electronic medical record, but may automatically be marked as confidential information 116 inaccessible to employer 106. Employer 106 may however be able to see, in real-time, the status 118 of the review (e.g., authorized, declined, more info requested).

In an embodiment, reviewer 108 may select a portion of results 112 and/or confidential information 116 and generate an authorized view 124. Authorized view 124 may include, for example, a selection of confidential information 116 or redacted portion of confidential information 116 that reviewer 108 determines employer 106 is authorized to view. This may include sharing documents, or portions thereof, provided by medical clinic as confidential information 116 that may be tangential to or otherwise supportive of results 112. This determination as to which information employer 106 is authorized to view may be based upon its relevance to medical procedure 111 and/or an employee's fitness to work, and on a case-by-base basis.

For example, medical clinic 110 may upload a document with the information gathered from employee 104 as part of a physical exam. Results 112 may indicate that employee 104 failed a physical exam 111. Reviewer 108 may review confidential information 116, and determine employee 104 failed due to a previous arm injury and include this in authorized view 124. An x-ray of the injury however may remain confidential information 116, inaccessible to employer 106.

In another embodiment, reviewer 108 may generate a new document to provide to employer 106 as authorized view 124. For example, reviewer 108 may review confidential information 116 and may produce a new document that includes relevant information for employer 106 without revealing any information employer 106 is not authorized to view due to employee confidentiality.

Throughout the medical review process, electronic medical evaluation system 100 may provide employer 106 real-time access to a status 118 of each employee 104 associated with the employer 106. Status 118 may be a general indication as to which medical procedure(s) 111 have been performed by medical clinic 110 and/or reviewed by reviewer 108. For example, status 118 may indicate that a request for medical procedure(s) 111 has been received, the request has been assigned to medical clinic 110, the medical clinic 110 has performed one or more of the medical procedures 111, whether or not the reviewer 108 has reviewed results 112, or whether additional information has been requested by reviewer 108 from medical clinic 110 or by reviewer 108 or medical clinic 110 from employee. Similar to what is described above, electronic medical evaluation system 100 may enable confidential and secure communications between medical clinic 110 or reviewer 108 and employee 104, which is not accessible to employer 106.

The electronic medical evaluation system 100 may grant employee 104 access to all or selected portions of results 112 and confidential information 116. The level of access provided to employee 104 may be determined by laws, regulations, and/or standards 114 in various embodiments. In an embodiment, when applying for job 122, employee 104 may be directed to an interface of electronic medical evaluation system 100 through which employee 104 provides medical history information. This medical history information may then be stored by electronic medical evaluation system 100 as part of the employee's electronic medical record. Then, for example, if employee 104 changes companies, the employee's previous medical information (including previous medical procedures 111 and results 112) would already be within electronic medical evaluation system 100, making the hiring process easier for both employees and employers. For example, with employee 104 authorization, electronic medical evaluation system 100 may release previous results 112 from medical procedures 111 performed with a different employer 106 to a new employer 106 of employee 104.

In an embodiment, employee 104 may request medical procedures 111. For example, employee 104 may have suffered an injury while working on job 122. Then for example, employee 104 may indicate where on his/her body is the location of the injury. For example, in an embodiment, electronic medical evaluation system 100 may provide a skeleton or outline of a human body showing the human anatomy (“body diagram”) on which employee 104 may point and click to indicate the location of injury or location of medical attention requirement on the employee 104. The body diagram may also be displayed and used by the medical clinic 110, the reviewer 108 and/or the employer 106 during data entry in their corresponding interface. Employee 104 may also provide information regarding how/when/the extent of the injury. This feature may also be provided by or accessible to employer 106. In an embodiment, employee 104 may have access to results 112, confidential information 116, and requested medical procedures 111 via an interface of electronic medical evaluation system 100.

The electronic medical evaluation system 100 provides a centralized system by which employers 106 are able to track the medical status 118 of employees 104 across one or more job 122 and/or locations. The electronic medical evaluation system 100 may provide a firewall that prevents employer 106 from accessing confidential information 116 of employee 104 in according with any regulations that may apply, all the while ensuring that employer's standards of care 114 are met. The electronic medical evaluation system 100 may provide a central repository of medical information for employees 104 across various employers 106, with varied levels of access to that information based on the roles of each user (e.g., employer 106, employee 104, medical clinic 110, and reviewer 108).

The electronic medical evaluation system 100 may also allow for audits of medical information for employees 104 across the company of employer 106. For example, with injury tracking, an employer 106 may be able to determine that a large number of heat strokes occurred with employees 104 working on a particular job 122 in a particular location. Then, for example, employer 106 may take corrective action (e.g., teaching employees 104 how to rehydrate properly, improve ventilation, reduce working hours, etc.) to prevent or reduce future injury. Or for example, electronic medical evaluation system 100 may provide employers 106 with a tool by which they are able to response to inquiries by the Occupational, Safety, and Health Administration (OSHA) or other bodies that may request information about worker safety.

In an embodiment, employee 104 may be working on a remote site for extended periods of time, in potentially, dangerous situations in which employee 104 may be injured on the job. In such situations, it would be helpful for employee's medical records/information/answers to be available to employer 106 or other personnel (e.g., such as medical personnel) if/when necessary. For example, an employee 104 may be injured while performing job 122 or otherwise on deployment for job 122, and rendered unconscious or otherwise unable to answer questions regarding their medical history. In such a situation, it would be helpful for medical (or other) personnel treating the injured employee 104 to have access to the employee's medical history/conditions as received and stored by electronics medical evaluation system 100.

In an embodiment, employer 106 may have a terminal or one or more mobile devices with remote access to electronics medical evaluation system 100 from the location where employee 104 is working. In normal operating circumstances, no personnel working for employer 106 at location may be able to access the employee's medical information. This may protect the employee's rights to medical confidentiality. However, select personnel (e.g., supervisors, medical personnel) may be provided with an emergency request 132 option. Emergency request 132 may include a code word that is provided, a configuration or authorization of a particular device, or other mechanism for selective access to the employee's medical information in emergency situations, such as those just described. For example, a mobile device issued to a supervisor may be provided emergency access to the medical information (e.g., such as an enabled emergency request 132 button or function), while a second mobile device issued to a non-supervisor employee may not have access to the medical information.

Then for example, if an emergency or other medical situation occurs at the remote location or other, the personnel with an enabled emergency request 132 may activate the emergency function to access the medical information of employee 104. For example, electronics medical evaluation system 100 grant temporary access to the medical history/information of employee 104. Emergency request 132 may be activated by hitting a button on the mobile device, entering a code, texting a particular number, etc. In an embodiment, emergency request 132 may be submitted for the employee's medical information. Upon verifying that the personnel/device is allowed emergency access to the medical information for the requested employee 104, electronics medical evaluation system 100 may grant temporary access to the medical information.

Electronics medical evaluation system 100 may log when (e.g., time/date) the request for emergency access was received, from whom it was received, which information was provided/requested, a global position (GPS) information or coordinates/site/location about from where the request was received, a length of time for which access was granted, or other information about the request, including when the request 132 was terminated or the emergency situation resolved. In an embodiment, access may be granted for a set period of time (e.g., 1 hour, 12 hours, 24 hours), or may be granted until a subsequent signal is received that the emergency situation has been resolved.

In an embodiment, the medical information may be stored locally on a particular device or terminal at the remote work location (e.g., particularly if the location does not have good network or other communication access). The information may then be unlocked as described with regard to the activation of emergency request 132 described above. Then for example, when network communication is established with electronics medical evaluation system 100, the logged information may be uploaded to electronics medical evaluation system 100.

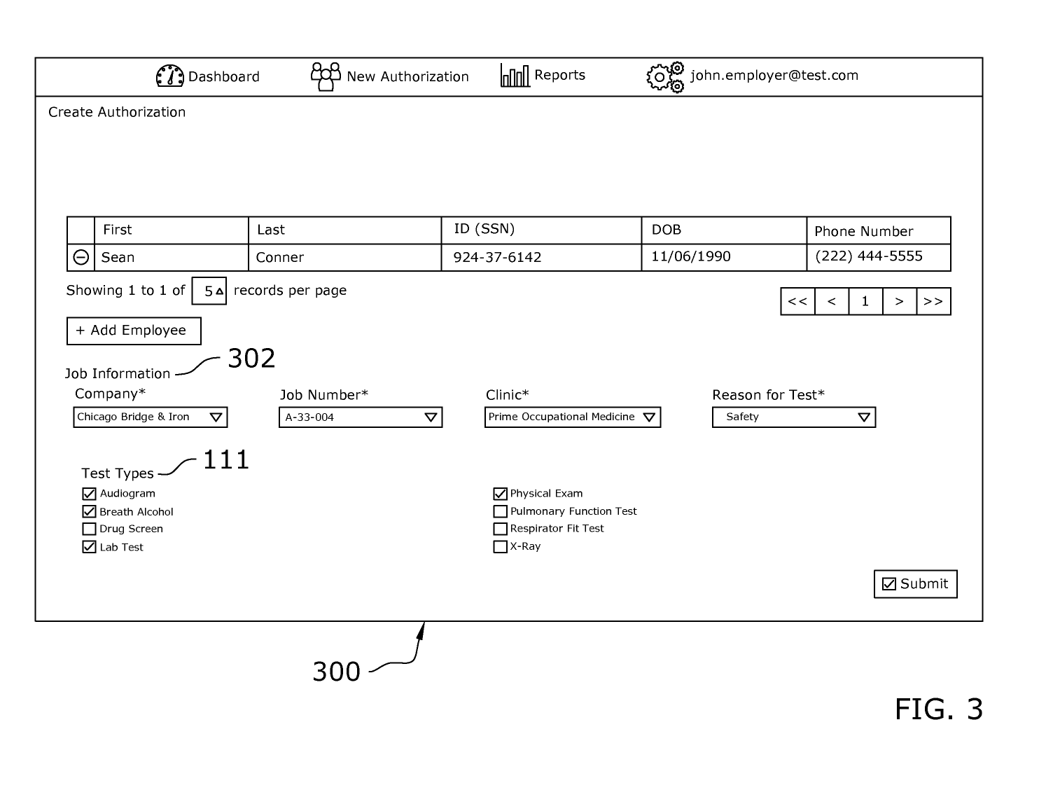

FIG. 2 is an example employer interface 200 of electronic medical evaluation system 100, according to an embodiment. Interface 200 is an example embodiment of an employer dashboard.

An employer 106, using employer dashboard is able to see the names of employees 104, their employee identifier, job numbers 122, the requested medical procedures 111 and/or reasons for requesting the procedure, which clinic 110 has been assigned the employee to perform the procedures, the status 118, and a time when the information was last updated.

Interface 200 may allow employer 106 to search for information, sort by job numbers, reasons, location, status, or any other information. In other embodiments, interface 200 may include additional and/or different information, such as an employee number, date requested, and cost (e.g., of the requested/performed procedures).

FIG. 3 is another example employer interface 300 of electronic medical evaluation system 100, according to an embodiment. Interface 300 is an example embodiment of a request interface where an employer 106 may request which medical procedures 111 are to be performed on an employee 104.

Employer 106 may, for example, select or provide one or more employees 104 for whom to request a selection of test types (medical procedures 111). As shown employer 106 may also specify job information 302. Job information 302 may include optional information employer 106 desires to provide. For example, the company field may indicate for which company employee 104 works. In an embodiment, employer 106 may be a main contractor and may have one or more sub-contractors working on the same project or job 122. In the company field, electronic medical evaluation system 100 may track to which contracting and/or sub-contracting company employee 104 is associated.

Employer 106 may also select which medical clinic 110 employer desires, or electronic medical evaluation system 100 may automatically provide clinic choices or a clinic selection. Employer 106 may also provide a reason for the test.

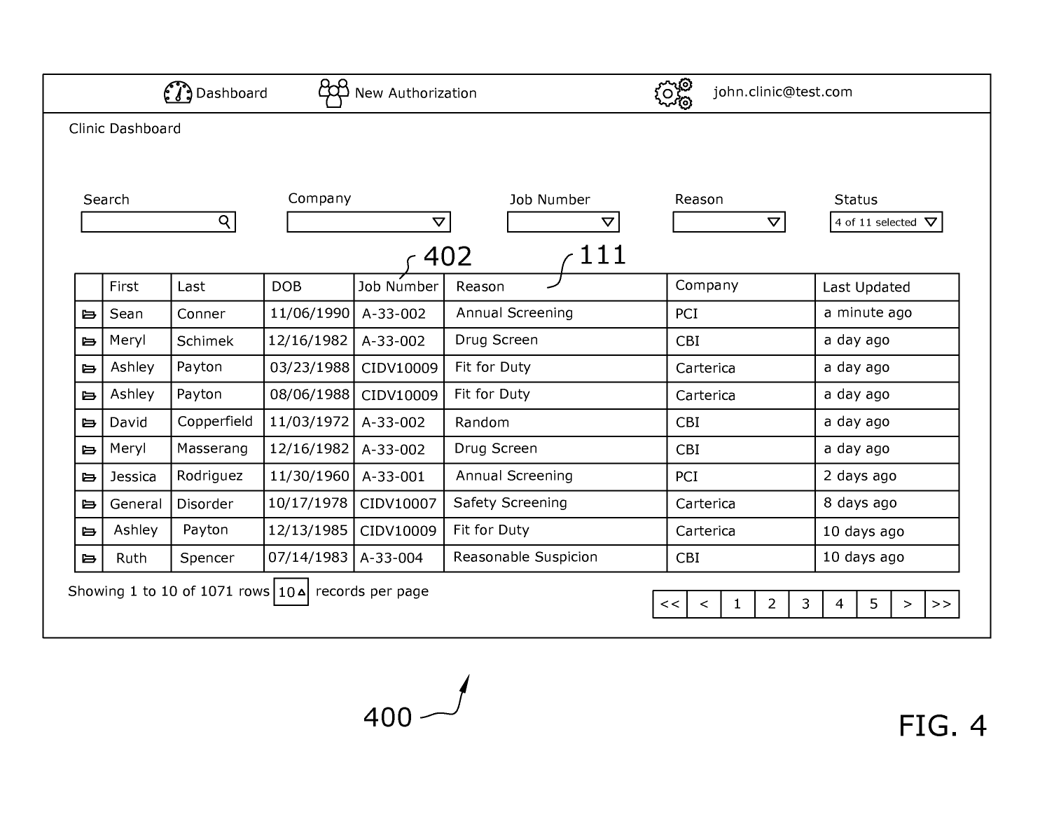

FIG. 4 is an example clinic interface 400 of electronic medical evaluation system 100, according to an embodiment. Interface 400 is an example embodiment of a clinic dashboard. A medical clinic 110, using clinic dashboard, is able to see the names of employees 104 assigned to the clinic by way of electronic medical evaluation system 100. Job number 402 may correspond to a job 122 of employer 106 or may an electronic medical evaluation system 100 internal job number, or clinic job number associated with the performance of one or more medical procedures 111 on the employee 104. Company field 106 may indicate the employer 106 of FIG. 1.

Similar to what was described above with respect to interface 200, medical clinic personnel may see different information and/or sort by any of the information presented. In an embodiment, the information presented on each or any interface may be toggled or adjusted by the respective employer 106, employee 104, reviewer 108, or medical clinic 110 accessing electronic medical evaluation system 100 via that interface as to which information is displayed on the interface. In an embodiment, electronic medical evaluation system 100 may be accessible to any of the parties via a web-based or mobile-device based interface.

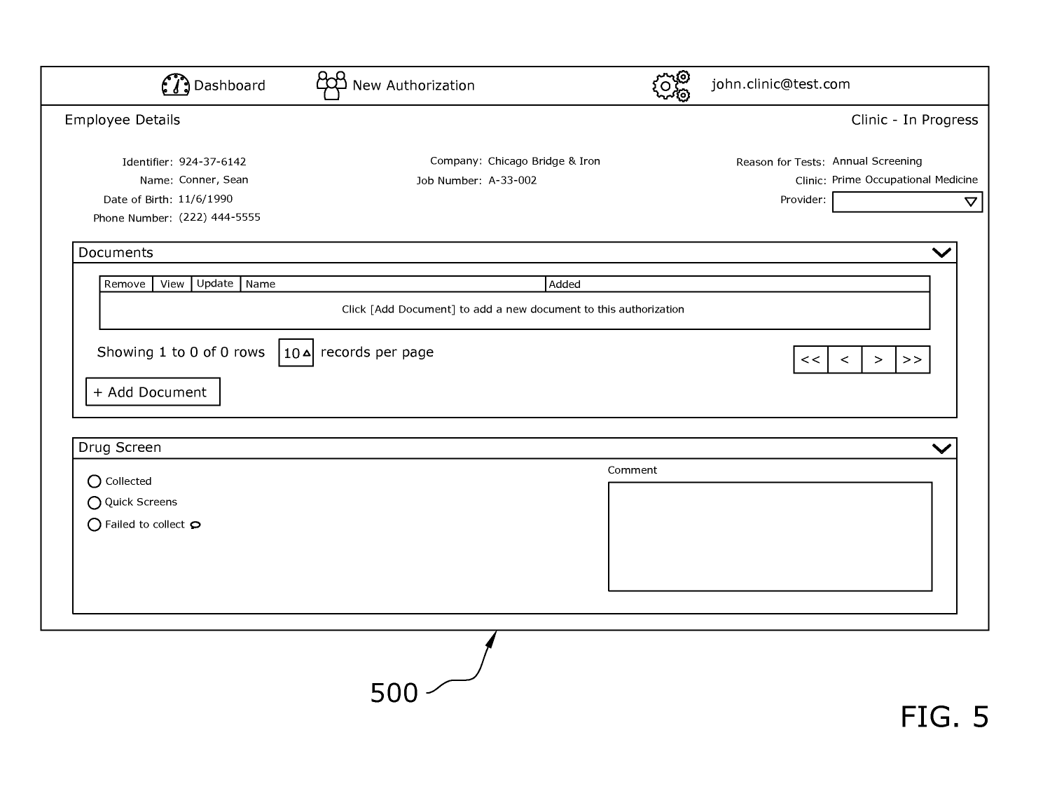

FIG. 5 is another example clinic interface 500 of electronic medical evaluation system 100, according to an embodiment. Interface 500 is an example embodiment of another clinic interface. The electronic medical evaluation system 100 may provide interface 500 to allow medical clinics 110 to update the status of medical procedures 111. Medical clinic 110 may also upload documents that may or may not include confidential information 116.

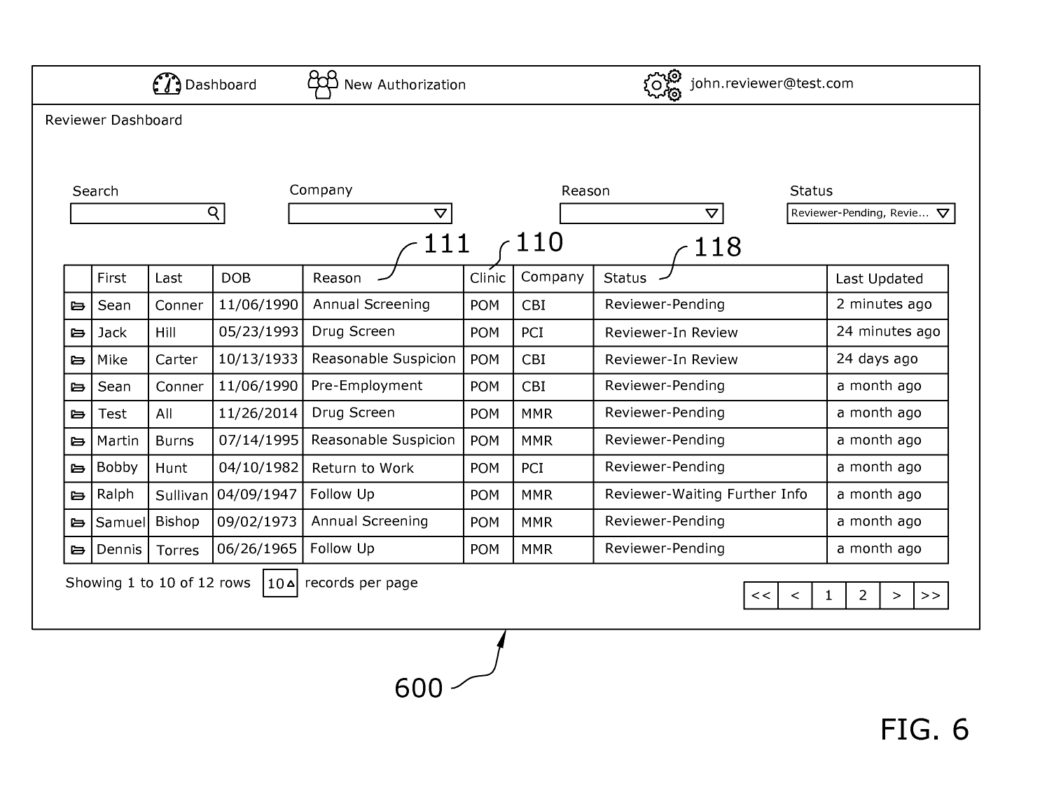

FIG. 6 is an example reviewer interface 600 of electronic medical evaluation system 100, according to an embodiment. Interface 600 is an example embodiment of a reviewer dashboard. A reviewer 108 may see which employees have been assigned to the reviewer 108 and the status of review. By clicking on the records, reviewer 108 may review in greater detail the medical information provided by medical clinic 110.

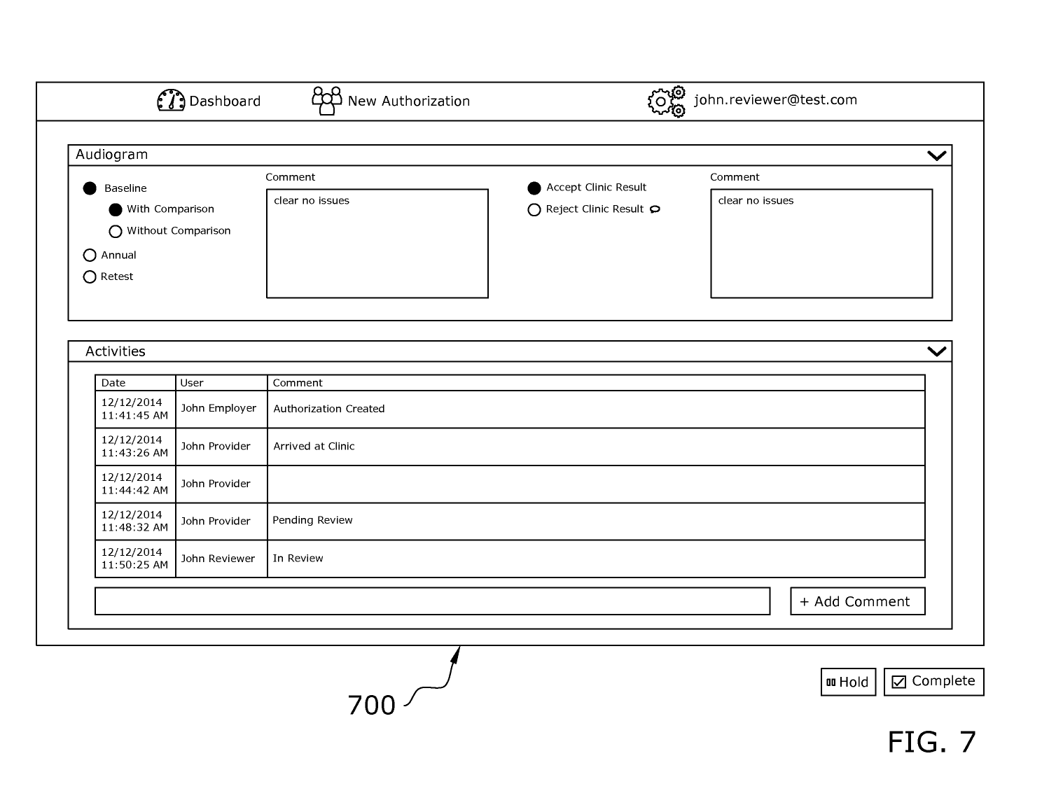

FIG. 7 is another example reviewer interface 700 of electronic medical evaluation system 100, according to an embodiment. Interface 700 is an example embodiment of a reviewer interface. By way of reviewer interface 700, a reviewer may see the information provided by clinic, and may enter notes with regard to the results 112 and/or confidential information 116 provided. Reviewer 108 may also be able to see a list of activities and when the activities took place with regard to an employee 104.

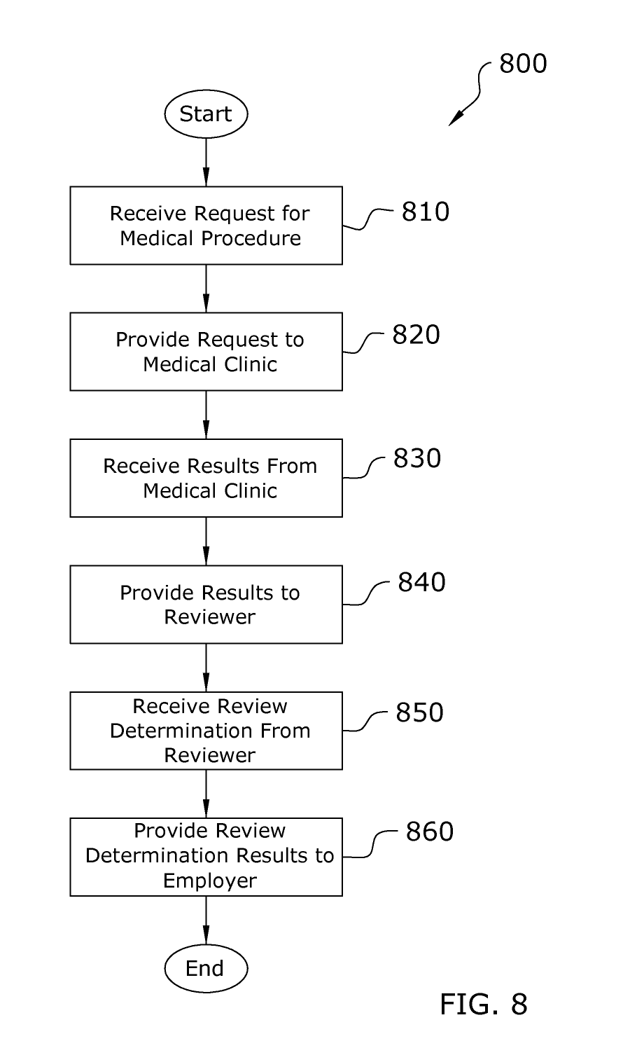

FIG. 8 is a flowchart 800 illustrating a process executed by electronic medical evaluation system 100, according to an example embodiment. At step 810, a request is received for a medical procedure. For example, the electronic medical evaluation system 100 may receive an employer 106 request for medical procedures 111 to be performed on employee 104. Or, for example, employee 104 may report an injury by way of employee interface 105 that requires one or more medical procedures 111. In an embodiment, employee 104 may not be required to provide any information directly to electronic medical evaluation system 100, but instead may provide information to employer 106 and/or medical clinic 110 as may be necessary to request and/or perform medical procedures 111.

At step 820, the request is provided to a medical clinic. For example, the electronic medical evaluation system 100 may provide or transmit the request to medical clinic 110. In an embodiment, electronic medical evaluation system 100 may automatically schedule an appointment for employee 104 and notify employee 104 and update status 118 with the appointment date/time. For example, electronic medical evaluation system 100 may coordinate an appointment based on an electronic calendar of employee 104 and/or medical clinic 110. In another embodiment, electronic medical evaluation system 100 may instruct medical clinic 110 to contact employee 104 to schedule an appointment, or vice versa. In another embodiment, no appointment may be scheduled with medical clinic 110, a new entry for an employee 104 on the medical clinic 110 dashboard may serve as notification to medical clinic 110 to expect employee 104.

At step 830, results are received from the medical clinic. For example, after one or more medical procedures 111 are performed or attempted performance (which may fail for any number of reasons) by medical clinic 110, results of the performance may be uploaded to otherwise provided to electronic medical evaluation system 100.

At step 840, the results are provided to a reviewer. For example, results 112 and confidential information 116 (if any) may be provide to reviewer 108. Confidential information 116 may include any information that supports or may otherwise be associated with the finding of results 112, but which may be protected by doctor-patient confidentiality, or for other reasons should not be accessible to employer 106.

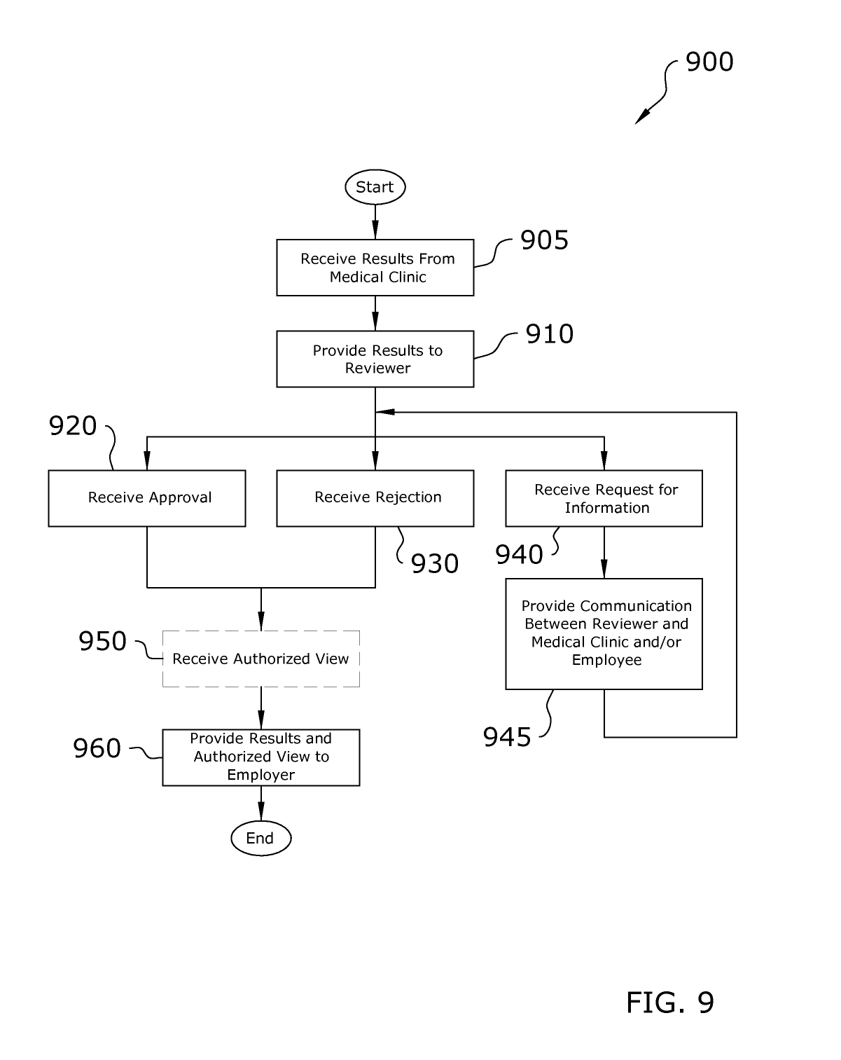

At step 850, a review determination is received from the reviewer. For example, reviewer 108 may perform a review process to ensure that the performance of medical procedures 111 conforms to standards 114. The review process is described in greater detail with regard to FIG. 9.

At step 860, the review determination and results are provided to the employer. For example, if results 112 are approved or rejected by reviewer 108, the results 112 and approval/rejection notice of reviewer may be provided to employer 106. However throughout the process, electronic medical evaluation system 100 may continually update status 118 indicating the last performed task or action with regard to the requested medical procedure(s) 111. As such, electronic medical evaluation system 100 provides employer 106 to real-time status 118 information without needing to separately contact employee 104, medical clinic 110, or reviewer 108.

FIG. 9 is a flowchart 900 illustrating an example review process, according to an embodiment. At step 905, results are received from a medical clinic. For example, a medical clinic 110 may provide results 112 and confidential information 116 to electronic medical evaluation system 100. In an embodiment, results 112 may indicate whether employee 104 passed/failed a particular exam, and confidential information 116 may include more detailed results as to why the employee 104 passed/failed.

At step 910, results are provided to reviewer 108. For example, electronic medical evaluation system 100 may provide results 112 and confidential information 116 to reviewer 108 for review. Prior to review by reviewer 108, results 112 may be inaccessible to employer 106. However, status 118 may be updated to indicate the results 112 have been received and are currently await or under review. During the review process, reviewer 108 may review results 112 and confidential information 116 to ensure standards 114 of employer 106 have been met for each medical procedure 111 performed by medical clinic 110. In an embodiment, the review may be performed on a procedure-by-procedure basis.

At step 920, an approval is received from the reviewer. For example, if reviewer 108 determines that the performance of medical procedure is in accordance with standards 114, reviewer 108 may approve results 112.

At step 930, a rejection is received from the reviewer. For example, if reviewer 108 determines that the performance of medical procedure is not in accordance with standards 114, reviewer 108 may reject results 112. The electronic medical evaluation system 100 may receive from reviewer 108 any reasons for the rejection, which may be provided to employer 106 and/or medical clinic 110.

At step 940, a request for additional information is received from the reviewer. For example, reviewer 108 may have questions or may not have enough information to determine whether or not the performance of medical procedures 111 was done in accordance with standards 114. The reviewer 108 may indicate as such, and electronic medical evaluation system 100 may update status 118 accordingly.

At step 945, communication between the reviewer and the medical clinic and/or employee is provided. For example, electronic medical evaluation system 100 may provide channels for confidential communication (e.g., not accessible to employer 106) between reviewer 108 and medical clinic 110 and/or employee 104. The electronic medical evaluation system 100 may allow for e-mail, video, voice, chat, or other communication between the parties. This communication may be stored with an employee's electronic medical record, but may not be made accessible to employer 106.

At 950, an authorized view may be received. Authorized view 124 may be any confidential information 116 provided by medical clinic 110 and/or employee 104 that reviewer 108 determines employer 106 is authorized to view. In an embodiment, reviewer 108 may have discretion to share necessary medical information provided by medical clinic 110 with employer 106. The information may be redacted, cut, or copied, such that only that portion of the information that is allowable (e.g., based on laws, standards 114, or other guidelines) is provided.

At 960, the results are provided to the employer. For example, electronic medical evaluation system 100 may transmit a notification that the requested medical procedures 111 have been performed by medical clinic 110 and have been reviewed by reviewer 108. The electronic medical evaluation system 100 may then enable employer 106 to access results 112 and authorized view 124.

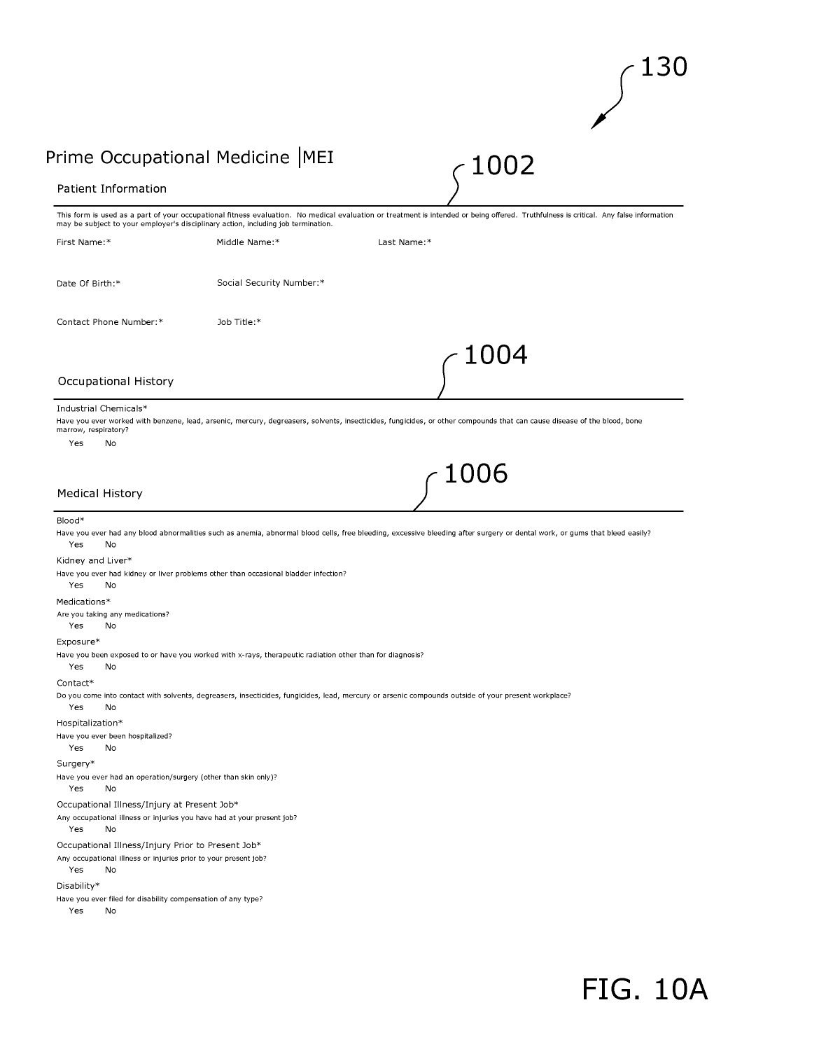

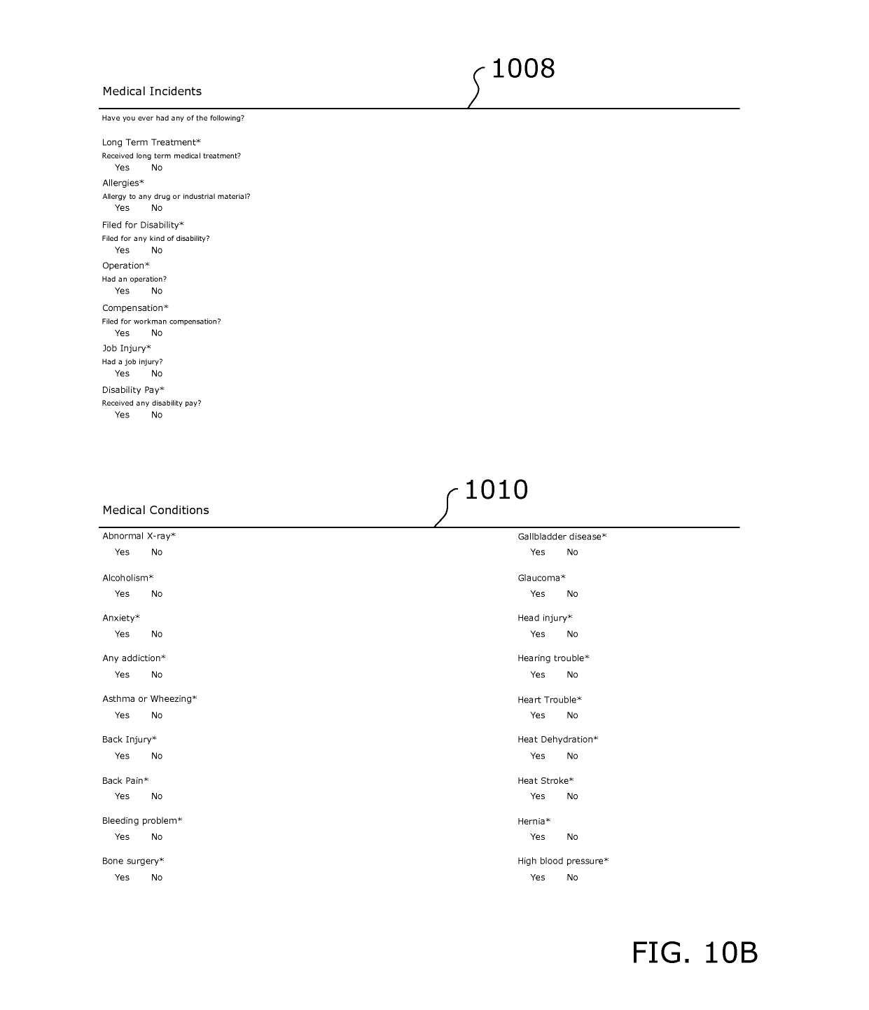

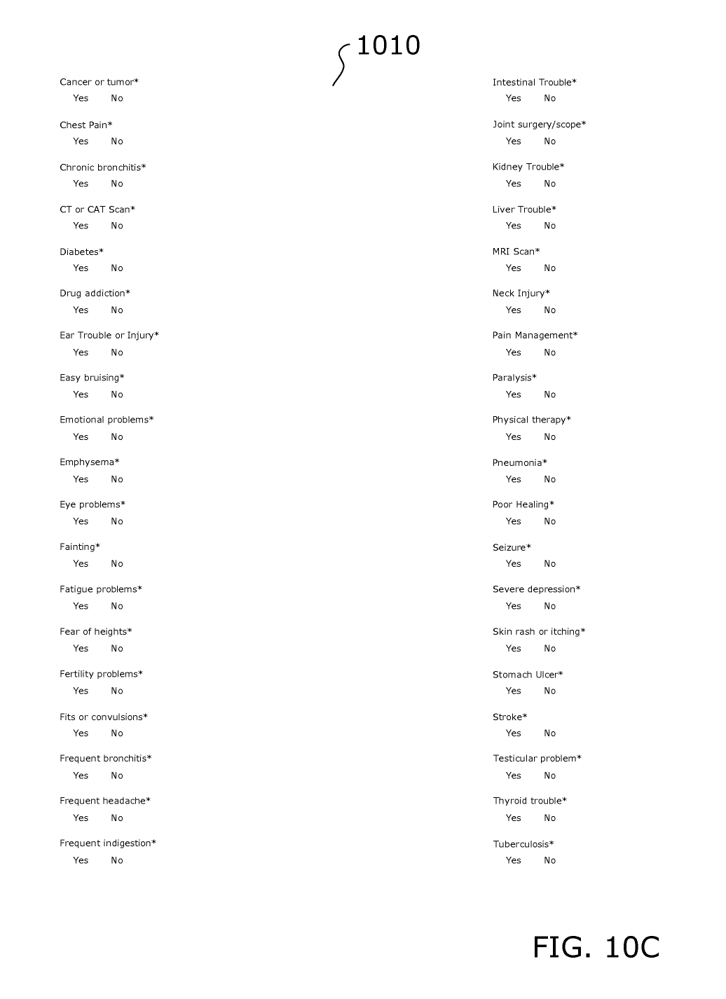

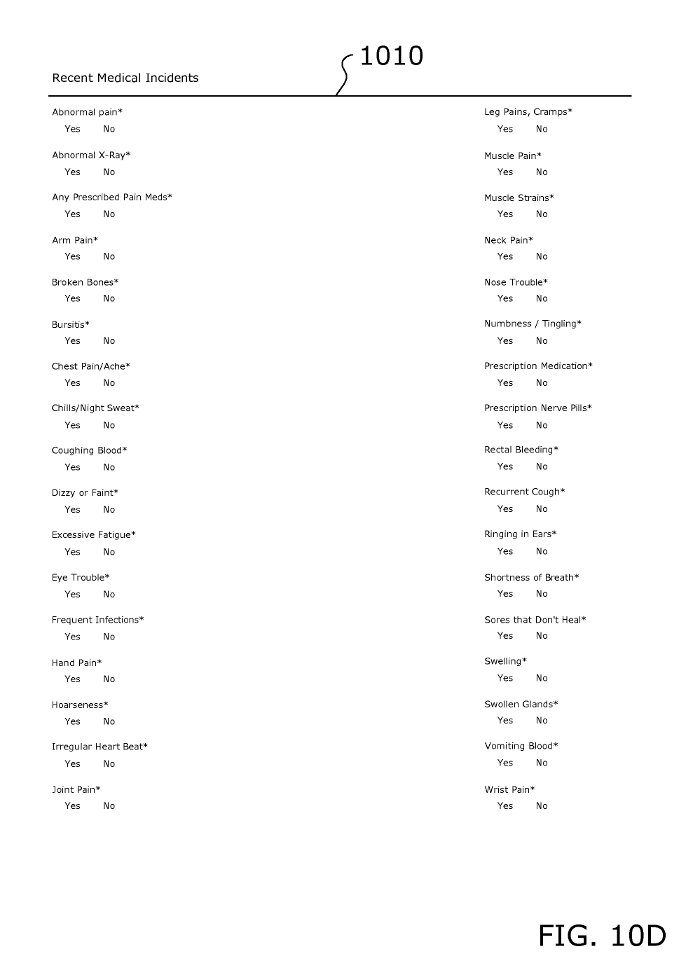

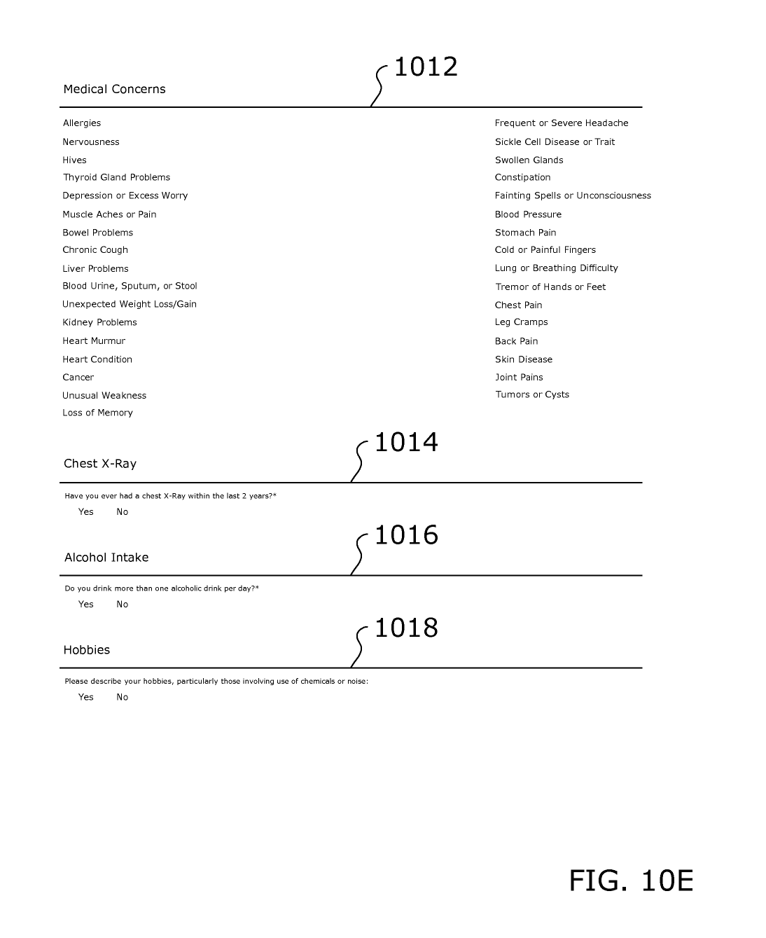

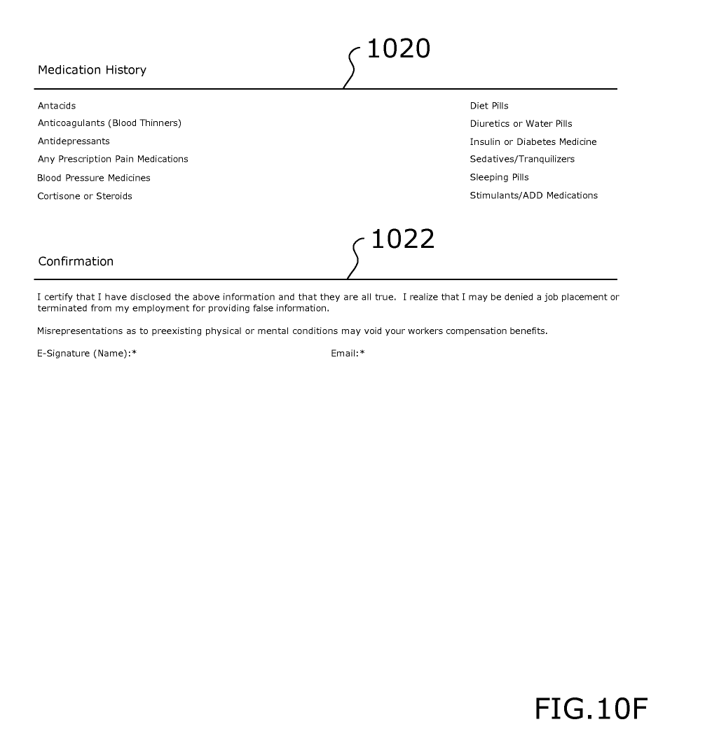

FIGS. 10A-F are example portions of a questionnaire 130 that may be provided by electronics medical evaluation system 100 to employee 104, according to an embodiment. In different embodiments, questionnaire 130 may be customized based on the employer 106, job 122, work location, weather conditions, employee 104, or other situations. The example questionnaire 130 will be described with reference to particular sections, but other questionnaires 130 may include additional and/or different sections than those described.

Patient information section 1002 may ask employee 104 to provide general identification information. In an embodiment, section 1002 and/or any other sections/questions may be automatically filled out by electronics medical evaluation system 100 based on information previously provided by employee 104. Employee 104 may then be requested to verify the information in each section and provide any updated information. Verification may include a signature, initial, or other acknowledgement as to the truthfulness or correctness of the information.

Occupational history section 1004 may include questions regarding the employee's previous exposure to potentially dangerous working conditions at job 122 or previous jobs held or performed by employee 104. Medical history section 1006 may include questions regarding a medical history of employee 104. Medical incidents section 1008 may include questions regarding any medical incidents that may have occurred with regard to employee 104. Medical conditions section 1010 may include questions regarding any existing or new medical conditions employee is or has become aware of Medical concerns section 1012 may include questions regarding any concerns employee 104 may have regarding their medical status (e.g., which may or may not have been diagnosed by a doctor or other medical professional).

X-ray section 1014 may include questions regarding whether or not employee 104 has had any or any recent x-rays performed. Alcohol/drug section 1016 may include questions to determine the employee's drug, alcohol, or other habits that may impact performance of job 122. Hobbies section 1018 may include questions to determine if employee engages in any social or recreational activities that may impact performance of job 122. Medication history section 1020 may include questions asking employee 104 to disclose any current, recent, or past over-the-counter and/or prescription medications employee 104 has been or is taking.

Confirmation section 1022 may request employee 104 to verify that all the information is accurate to the best of employee's knowledge, and sign, date, and/or initial the verification. In an embodiment, if a section 1002-1020 was filled out based on the existing information about employee 104, questionnaire 103 may include one or more separate confirmation sections 1022 to confirm for each section that the filled out information is still accurate.

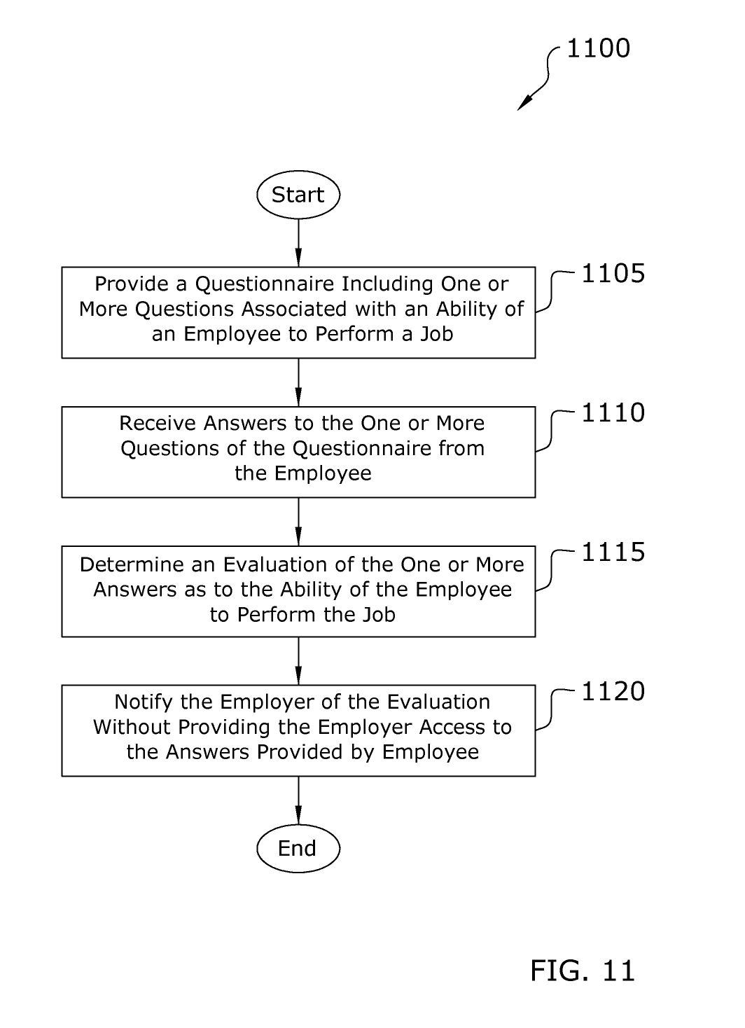

FIG. 11 is a flowchart 1100 illustrating an example process of evaluating whether an employee is able to perform a job, according to an embodiment. At step 1105, a questionnaire including or more questions associated with an ability of an employee to perform a job for an employer is provided. For example, electronics medical evaluation system 100 may provide questionnaire 130 to employee 104 via employee interface 105. Questionnaire 130 may include questions regarding whether employee 104 has had any new or updated medical conditions between a previous deployment to perform job 122 and a subsequent, scheduled, or current deployment for job 122 (which may be a same or different job, in a same or different location). Questionnaire 130 may be customized for each job 122, employer 106, job location, and/or employee 104. In an embodiment, questionnaire 130 may be provided in conjunction with injury indicator 107 to receive any updated medical information/medical history from employee 104.

At step 1110, answers to the one or more questions of the questionnaire are received from the employee. For example, electronics medical evaluation system 100 may receive answers to questionnaire 130 from employee 104. In an embodiment, electronics medical evaluation system 100 may provide questionnaire 130 with one or more answers filled in based on a medical history of employee 104. Then for example, electronics medical evaluation system 100 may receive a verification from employee 104 as to whether or not the provided answers are still accurate.

At step 1115, an evaluation of the one or more answers is determined as to the ability of the employee to perform the job. For example, electronics medical evaluation system 100 may determine that there were no updates to the medical conditions of employee 104 and clear the employee 104 to perform job 122. In an embodiment, the clearance may occur without a review by reviewer 108. Or, for example, electronics medical evaluation system 100 may determine that there has been one or more updates to the medical condition of employee 104, and the answers may be reviewed by reviewer 108.

Reviewer 108 may then determine whether or clear, conditionally clear, or not clear employee 104. Conditional clearance may include clearing employee 104 to perform job 122 with certain restrictions. These restrictions may include waiting a period of time before returning to work, physical therapy, limited work hours, limited work conditions (e.g., cannot lift more than a specified amount of weight), or other restrictions. In an embodiment, if employee 104 is conditionally cleared or not cleared to perform job 122, employee 104 may be scheduled for further evaluation at medical clinic 110.

At step 1120, the employer is notified of the evaluation without providing the employer access to the answers provided by the employee. For example, employer 106 may be provided updates to the evaluation/clearance of employee 104 via electronics medical evaluation system 100 dashboard. Employer 106 may, however, be prohibited from accessing employee 104 answers or medical information unless an emergency medical situation arises as described above. Then for example, employer 106 (e.g., or certain personnel, such as supervisors or medical personnel) may be granted conditional, limited, or temporary access to the medical information (including answers and/or medical history) may be required or helpful to treat a medical condition encountered by employee 104.

The present invention may be utilized upon any telecommunications network capable of transmitting data including voice data and other types of electronic data. Examples of suitable telecommunications networks for the present invention include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN). The present invention may communicate via a single telecommunications network or multiple telecommunications networks concurrently. Various protocols may be utilized by the electronic devices for communications such as but not limited to HTTP, SMTP, FTP and WAP (wireless Application Protocol). The present invention may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The present invention may also be utilized with online services and Internet service providers.

The Internet is an exemplary telecommunications network for the present invention. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

The central communication unit may be comprised of any central communication site where communications are preferably established with. The central communication units may be comprised of a server computer, cloud based computer, virtual computer, home computer or other computer system capable of receiving and transmitting data via IP networks and the telecommunication networks. As can be appreciated, a modem or other communication device may be required between each of the central communication units and the corresponding telecommunication networks. The central communication unit may be comprised of any electronic system capable of receiving and transmitting information (e.g. voice data, computer data, etc.).

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

The invention claimed is:

1. A method, comprising:
providing a questionnaire comprising one or more questions associated with an ability of an employee to perform a job for an employer;
receiving answers to the one or more questions of the questionnaire from the employee;
determining an evaluation of the one or more answers as to the ability of the employee to perform the job; and
notifying the employer of the evaluation without providing the employer access to the answers provided by the employee.

2. The method of claim 1, wherein the providing comprises:
providing the questionnaire including providing answers to one or more of the questions generated based on a medical history of the employee.

3. The method of claim 1, wherein the providing comprises:
providing the questionnaire, wherein the one or more questions are associated with determining whether the employee encountered any new medical conditions between a previous deployment when the employee performed the job, and a future deployment to perform the job.

4. The method of claim 1, further comprising:
receiving an emergency request to access the answers and medical information of the employee, wherein the emergency request is associated with a medical situation that has occurred during the employee's deployment to perform the job; and
providing access to the answers and medical information responsive to the emergency request, wherein access to the answers and medical history is not granted absent the emergency request.

5. The method of claim 4, further comprising:
logging information associated with the emergency request, wherein the logged information includes a time when the request was made, an identifier of a mobile device or personnel from which the emergency request was received, which answers or other medical information was requested, and a length of time for how long access to the answers and medical information was granted.

6. The method of claim 4, wherein the providing access comprises:
providing access to the answers and other medical information associated with the employee until an indication is received that the emergency situation no longer exists.

7. The method of claim 1, wherein the evaluation comprises determining that the employee is cleared to perform the job, conditionally cleared to perform the job, or not cleared to perform the job.

8. The method of claim 7, further comprising:
scheduling a medical evaluation with a medical professional if the employee is conditionally cleared to perform the job or not cleared to perform the job.

9. The method of claim 7, further comprising:
notifying the employee of the medical evaluation.

10. A system comprising one or more processors coupled to a non-transitory memory, that are configured when executed to:
provide a questionnaire comprising one or more questions associated with an ability of an employee to perform a job for an employer;
receive answers to the one or more questions of the questionnaire from the employee;
determine an evaluation of the one or more answers as to the ability of the employee to perform the job; and
notify the employer of the evaluation without providing the employer access to the answers provided by the employee.

11. The system of claim 10, wherein the processors configured to provide are configured to:
provide the questionnaire including providing answers to one or more of the questions generated based on a medical history of the employee.

12. The system of claim 10, wherein the processors configured to provide are configured to:
provide the questionnaire, wherein the one or more questions are associated with determining whether the employee encountered any new medical conditions between a previous deployment when the employee performed the job, and a future deployment to perform the job.

13. The system of claim 10, wherein the one or processors are further configured when executed to:
receive an emergency request to access the answers and medical information of the employee, wherein the emergency request is associated with a medical situation that has occurred during the employee's deployment to perform the job; and
provide access to the answers and medical information responsive to the emergency request, wherein access to the answers and medical history is not granted absent the emergency request.

14. The system of claim 13, wherein the one or processors are further configured when executed to:
log information associated with the emergency request, wherein the logged information includes a time when the request was made, an identifier of a mobile device or personnel from which the emergency request was received, which answers or other medical information was requested, and a length of time for how long access to the answers and medical information was granted.

15. The system of claim 13, wherein the processors configured to provide access are configured to:
provide access to the answers and other medical information associated with the employee until an indication is received that the emergency situation no longer exists.

16. The system of claim 10, wherein the evaluation comprises determining that the employee is cleared to perform the job, conditionally cleared to perform the job, or not cleared to perform the job.

17. The system of claim 16, wherein the one or processors are further configured when executed to:
schedule a medical evaluation with a medical professional if the employee is conditionally cleared to perform the job or not cleared to perform the job.

18. The system of claim 16, wherein the one or processors are further configured when executed to:
notify the employee of the medical evaluation.

19. A computer program product tangibly embodied on a non-transitory computer readable medium that when executed by one or more processors, causes the one or more processors to:
provide a questionnaire comprising one or more questions associated with an ability of an employee to perform a job for an employer;
receive answers to the one or more questions of the questionnaire from the employee;
determine an evaluation of the one or more answers as to the ability of the employee to perform the job; and
notify the employer of the evaluation without providing the employer access to the answers provided by the employee.
